(19) United States
(12) Patent Application Publication
(10) Pub. No.: US 2019/0353621 A1
(43) Pub. Date: Nov. 21, 2019

(54) FLUID EMITTER SYSTEM FOR TUBULAR INSPECTION

(71) Applicant: QUANTA ASSOCIATES, L.P., Houston, TX (US)

(72) Inventors: David S. Smith, Traverse City, MI (US); Dean M. Vieau, Traverse City, MI (US); Douglas W. Spencer, Rapid City, MI (US)

(21) Appl. No.: 16/006,197

(22) Filed: Jun. 12, 2018

Related U.S. Application Data
(60) Provisional application No. 62/674,061, filed on May 21, 2018.

(51) Int. Cl. G01N 29/24; G01N 29/04; G01N 29/12

(52) U.S. Cl. CPC G01N 29/2431; G01N 29/043; G01N 2291/0289; G01N 2291/2636; G01N 29/12

(57) ABSTRACT

A crack detecting system includes a tool movable along a conduit or structure and having at least one sensing device for sensing cracks in a wall of the conduit or structure. The sensing device includes a fluid emitter and the fluid emitter includes at least one orifice configured to emit fluid. In response to the orifice emitting fluid, the emitted fluid excites the conduit or structure and the sensing device senses a response from the excitation of the conduit or structure. A processor is operable to process the response sensed by the sensing device and responsive to the processing, the processor determines flaws present at the wall of the conduit or structure.

### CROSS REFERENCE TO RELATED APPLICATION

The present application claims the filing benefits of U.S. provisional application Ser. No. 62/674,061, filed May 21, 2018, which is hereby incorporated herein by reference in its entirety.

### FIELD OF THE INVENTION

The present invention relates generally to a system and method of detecting cracks or other flaws in a pipeline or conduit or tubular via a tool or device that is moved along and within the pipeline or conduit or tubular (or moved along an exterior surface of a conduit or tubular or plate or beam or other structure).

### BACKGROUND OF THE INVENTION

It is known to use a sensing device to sense or determine the flaws or defects in pipes and other tubulars. Examples of such devices are described in U.S. Pat. Nos. 8,061,207; 8,201,454; 8,319,494; 8,356,518 and 8,479,577.

### SUMMARY OF THE INVENTION

The present invention provides a crack/flaw detecting system that includes a tool movable along a conduit or structure and having at least one sensing device for sensing cracks in a wall of the conduit or structure. The sensing device includes a fluid emitter and the fluid emitter includes at least one orifice configured to emit fluid. In response to the orifice emitting fluid, the emitted fluid excites the conduit or structure and the sensing device senses a response from the excitation of the conduit or structure. A processor is operable to process the response sensed by the sensing device and the responsive to the processing, the processor determines flaws present at the wall of the conduit or structure.

These and other objects, advantages, purposes and features of the present invention will become apparent upon review of the following specification in conjunction with the drawings.

### BRIEF DESCRIPTION OF THE DRAWINGS

FIGS. 1A-B show side plan views of tools in accordance with aspects of the invention;

FIG. 2 shows a plan view of a tool with angled manifolds in accordance with the present invention;

FIGS. 3A-B show side plan views of tools with exemplary manifold configurations according to aspects of the invention;

FIG. 4 shows a side plan view of a tool with exemplary orifice configurations according to aspects of the invention;

FIG. 5 is a schematic of exemplary orifice shapes suitable for use with the present invention;

FIGS. 6A-C are flow diagrams showing fluid regulation according to aspects of the present invention;

FIG. 7 is a flow diagram showing fluid regulation according to an aspect of the present invention;

FIG. 8 is a flow diagram showing fluid regulation according to an aspect of the present invention;

FIGS. 9A-B are sectional views of flow control valves suitable for use with the present invention;

FIGS. 10A-B are sectional views of flow control valves suitable for use with the present invention;

FIGS. 11A-B are sectional view of manifolds with insert bodies suitable for use with the present invention;

FIGS. 12A-B are a sectional view and plan view of an insert body with angled orifices suitable for use with the present invention;

FIG. 13 is a sectional view of a manifold with diverging fluid emissions suitable for use with the present invention;

FIGS. 14A-B are a sectional view and plan view of an insert body with angled orifices suitable for use with the present invention;

FIG. 15 is a sectional view of a manifold with parallel fluid emissions suitable for use with the present invention;

FIG. 16 is a plan view of an insert body with random orifice orientations suitable for use with the present invention;

FIG. 17 is a sectional view of an insert body with a variable area fluid emission exit suitable for use with the present invention;

FIG. 18 is a sectional view of a manifold with integrated flow control valve suitable for use with the present invention;

FIG. 19 is another tool with a power source drive assembly in accordance with the present invention;

FIGS. 20A-C are flow diagrams showing a power source drive assembly powering aspects of the invention;

FIG. 21 is a sectional view of a tool with a plurality of pumps or compressors in accordance with the present invention;

FIGS. 22A-B are flow diagrams of fluid emitter systems with multiple pumps or compressors;

FIG. 23 is a perspective view of intersecting fluid discharge from an insert body in accordance with the present invention;

FIGS. 24A-D are sectional views of insert bodies with integrated chaotic cavities suitable for use with the present invention;

FIG. 25 is a plan view of a tool including a manifold with integrated metamaterials;

FIG. 26 is a sectional view of a manifold including an insert body with an integrated chaotic cavity suitable for use with the present invention;

FIG. 27 is a downhole tool including exit orifices, insert bodies, and metamaterials integrated into sensor shoes;

FIG. 28 is a sectional view of a fluid emitter system within a tubular in accordance with the present invention;

FIG. 29 is a sectional view of a fluid emitter system on the surface of a tubular in accordance with the present invention;

FIG. 30 is a sectional view of a fluid emitter system with a power source drive wheel assembly within a tubular in accordance with the present invention; and

FIG. 31 is a sectional view of a fluid emitter system with metamaterials within a tubular in accordance with the present invention.

### DESCRIPTION OF THE PREFERRED EMBODIMENTS

The present invention provides a system and method and apparatus for determining flaws (e.g., cracks) in pipelines or well casings, and other tubulars or conduits. The tool can be operated in pipelines (such as, for example, for inline inspection), downhole applications (drill strings, well casing and tubing), and other tubulars, or the tool may be moved along an exterior surface of a conduit or tubular or plate or beam or other structure. The tool includes at least one sensing device that senses flaws in the wall of the conduit or structure. The sensing device includes a fluid emitter which has at least one orifice configured to emit fluid (e.g., a gas or a liquid). The emitted fluid impinges and excites the structure and the sensing device senses a response from the excitation of the structure. A processor processes the response determines flaws present at the wall of the conduit or structure.

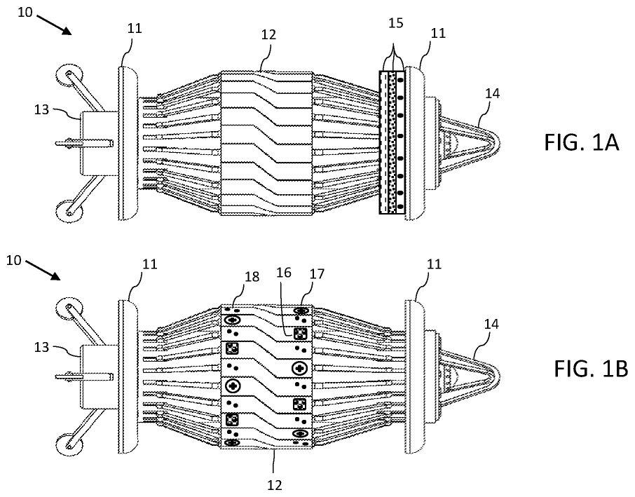

Referring now to the drawings and the illustrative embodiments depicted therein, FIGS. 1A and 1B illustrate a tool 10 with fluid manifolds 15 of varying orifice shapes, sizes, and densities, that are configured to emit fluid. As shown, the tool 10 may also include one or more drive cups, centralizers, or cleaning rings 11 or some combination thereof. The tool 11 may also include sensor or sensing shoes 12. The sensor shoes 12 may include metamaterials 16, one or more insert bodies 17, or orifices 18 integrated into the sensor shoes 12 that are capable of sensing responses from the emitted fluid, the material under test, or some combination of the two. Alternatively, orifices 18 of varying sizes and shapes may be located on manifolds 15. Orifices 18 emit fluid that impinges and excites a surface of the conduit or structure. The emitted fluid may be used individually or in combination with control of time series emissions composed of noise, random, periodic, chaotic and/or hyperchaotic emitting patterns. The system achieves broadband/wideband emission spectra or random excitation sequences by virtue of control of the fluid (e.g., control of pressure, mass flow, etc.).

The fluid emitters may emit a single fluid or a plurality of different fluids that are mixed within the tool or external to the tool prior to impinging the structure. The fluid type affects the response received from the structure (e.g., a frequency), therefore mixing fluids can achieve specific frequency ranges. Optionally, the tool dynamically controls the orientation of the orifices to direct the fluid emission, or alternatively, the tool relies on static angle orientation. Fluid emissions may be pre-configured or dynamically changed during tool operation. Sensors, for example sensor shoes 12, detect a response from the excited structure. Orifices 18 location may be placed strategically proximate to sensors on sensor shoes 12 for optimal excitation and receiving characteristics. For example, defects responding to a given range of frequencies may produce a time series emission profile such that a crack/flaw responds through various forms of crack/flaw resultant energy return signal changes (e.g., reflection, dispersion, attenuation, resonance, anti-resonance, velocity change, etc.). Due to this motion, the detection system sensors respond to the relative frequency/amplitude variations reflecting the presence and characterization of a related defect.

A processor (not shown) receives the sensed response and processes the response to determine flaws, such as cracks, at the surface of the conduit or structure. Referring back to FIGS. 1A and 1B, a power source drive wheel assembly 13, as discussed in more detail below, may provide power to the tool 11. In some examples, the tool 11 is propelled via pull or tow loops 14.

The fluid emitted may be tuned to excite in a broadband manner—for example, via pretuned before the inspection run, or through dynamic means (e.g., valve, variable area orifice, etc.) during the inspection run. An emitted broadband frequency spectrum has an improved ability to excite the natural frequencies of a crack/flaw within the conduit or structure—thus generating improved relative motion of the crack/flaw to the parent material of the conduit or structure. The system generates relative motion of the crack/flaw (with or without exciting the crack/flaw natural frequencies) to provide an easily detectable response. Flow pattern time series variations correlate to various frequency components and their related amplitudes. Dynamic time series pressure or mass flow control allows for customization of frequency spectra as required by a given application.

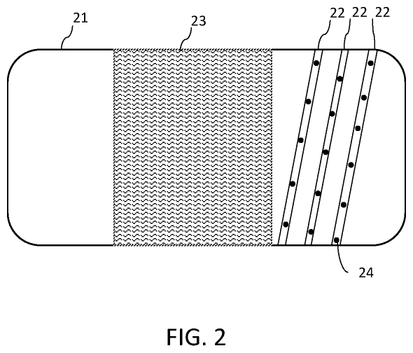

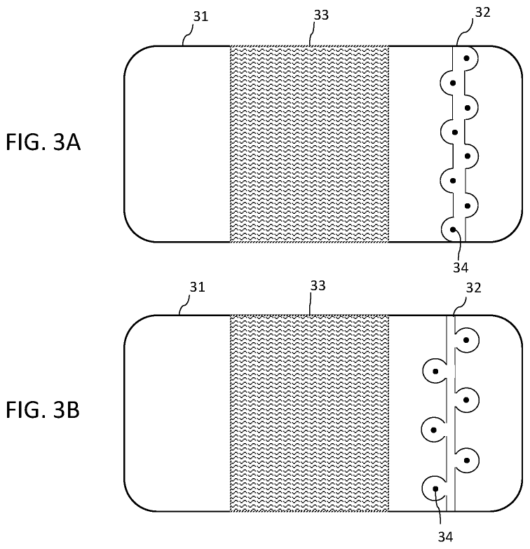

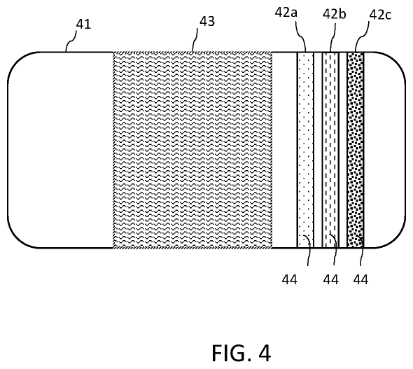

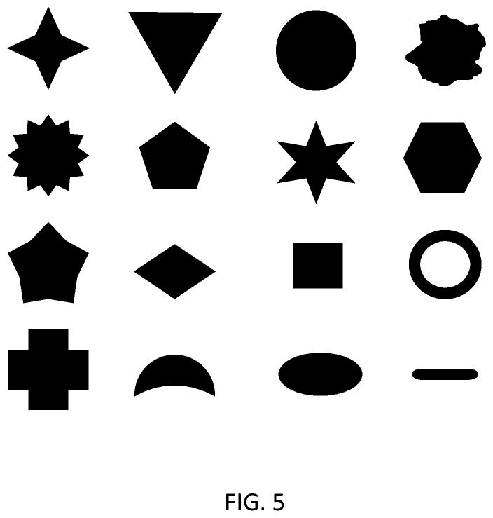

The manifolds may be configured in a variety of shapes and sizes. For example, tool 21 may have manifolds 24 with orifices 24 and sensing region 23 (FIG. 2). In other examples, as shown in FIGS. 3A and 3B, tool 31 may have manifolds 32 with orifices 34 and sensing region 33. The orifices may also have a variety of shapes, sizes, densities, and cross-sections. Orifices may be in any orientation or configuration, including exit angles, axial spacing along the tool, circumferential spacing around the tool, overlap of fluid discharge, length of orifice exit path, and the like. Referring now to FIG. 4, tool 41 with sensing region 43 may have manifolds 42a-c, each with orifices 44. As non-limiting examples, the manifold may have pinhole orifices (42a), slotted orifices (42b), or dense pattern orifices (42c). Other examples of orifice shapes can be seen in FIG. 5.

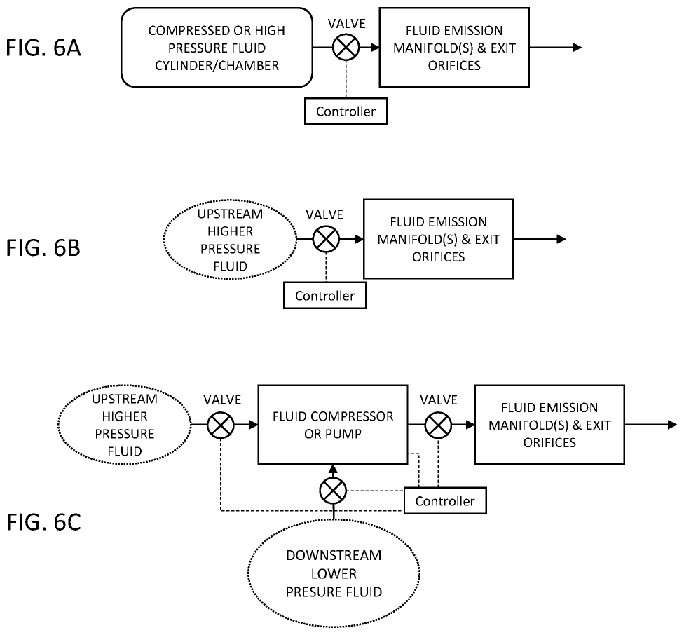

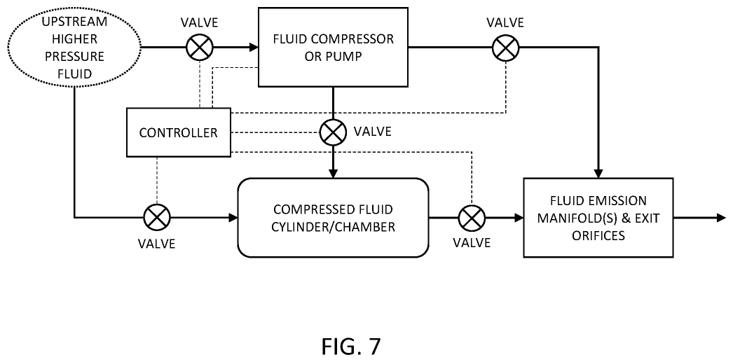

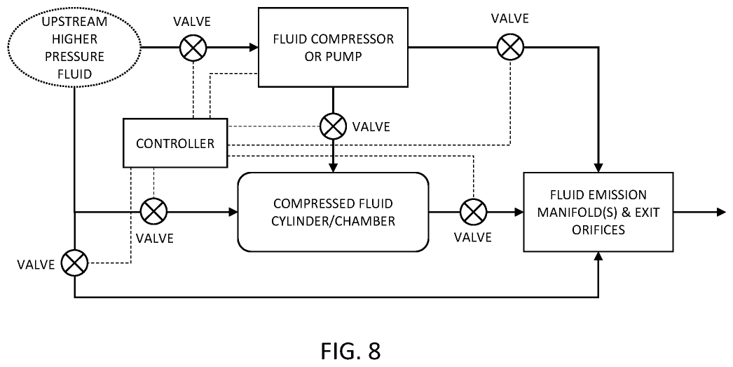

FIGS. 6A-C illustrate example flow diagrams for fluid emitter system configurations for collecting or storing the fluid prior to emission. For example, as shown in FIG. 6A, a module may store compressed fluid and regulate the fluid to the manifolds via a valve that optionally is operated by a controller. In another example, the fluid may be collected from an environment surrounding the tool. Specifically, high pressure fluid upstream of the tool may be regulated to the manifold via a valve that also may be operated by a controller (FIG. 6B). Alternatively, such as shown in FIG. 6C, a fluid compressor or pump may collect fluid from both an upstream higher pressure fluid and a downstream lower pressure fluid through valves. The compressor, which may be included in the manifold, provides the manifold collected fluid through yet another valve, all of which may be operated by controllers. As illustrated in FIGS. 7 and 8, the compressor and fluid pressure differential may be combined with a fluid storage module, again with valves and optional controllers. The tool may fill the fluid storage module or the fluid module may be pre-filled prior to the tool's use. The valves may be operated via means such as, for example, mechanical, electro-mechanical, electro-magnetic, hydraulic, magnetic, pneumatic, etc.

The controllers may provide fast switching for controlled or continuous pulsing of fluid through a high-speed valve. Besides optimized chaotic broadband excitation in a discrete time window, precise pulsing of the emitted fluid also allows for better and more efficient metering of the available fluid, which may be especially valuable when fluid is not able to be collected from the environment. Power requirements may also be greatly reduced. Pulsed emissions may be timed to emit fluid at differing time windows per orifice or per manifold to generate additional chaotic emission behavior, and establish the desired broadband frequency excitation range. In order to achieve high rates of speed, the valves may include rolamite mechanisms. Rolamite mechanisms provide bearings with very low losses to friction.

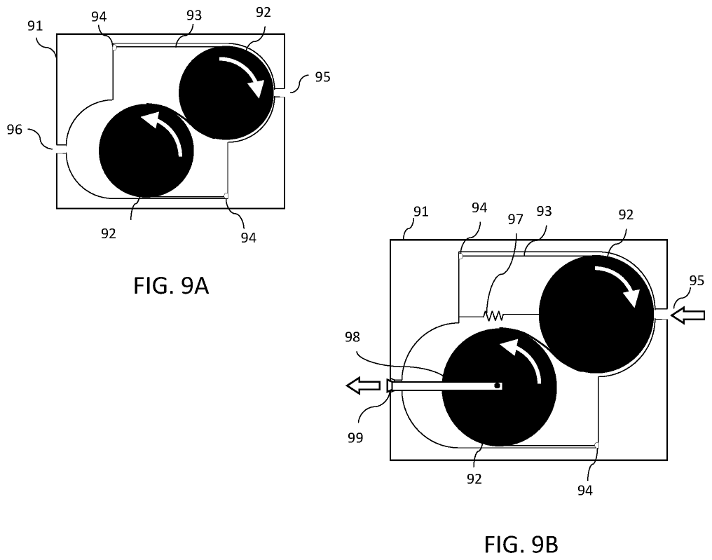

As shown in FIGS. 9A and 9B, the valve (or insert) body 91 of the rolamite mechanism includes rollers 92 with a tension band 93 and tension band anchors 94. Fluid may enter the valve body at inlet 95 and exit at outlet 96. A biasing element, such as a spring 95, may be included to bias the rollers 92. A pin, bolt, poppet valve, or pintle 99 may guide one or both of the rollers 92 as they move through valve body 91. The rollers 92 move the pintle 99 to open the valve exit or to close the valve exit. As the pintle 99 moves to the left in FIG. 9B, the valve exit orifice opens, and the exit area becomes larger (variable area exit orifice). The exit area orifice is annular. The valve/insert body 91 guides the pintle 99 as does the rollers. There may be a guide bushing or other component to assure that the pintle 99 does not bias to a side. The fluid pressure and the attachment to the rolamite roller 92 will maintain reasonable centering of the pintle 99 during operation. When the flow is eliminated, and the pintle 99 retracted, the flare at the end of the pintle 99 seats into place at the insert/valve body.

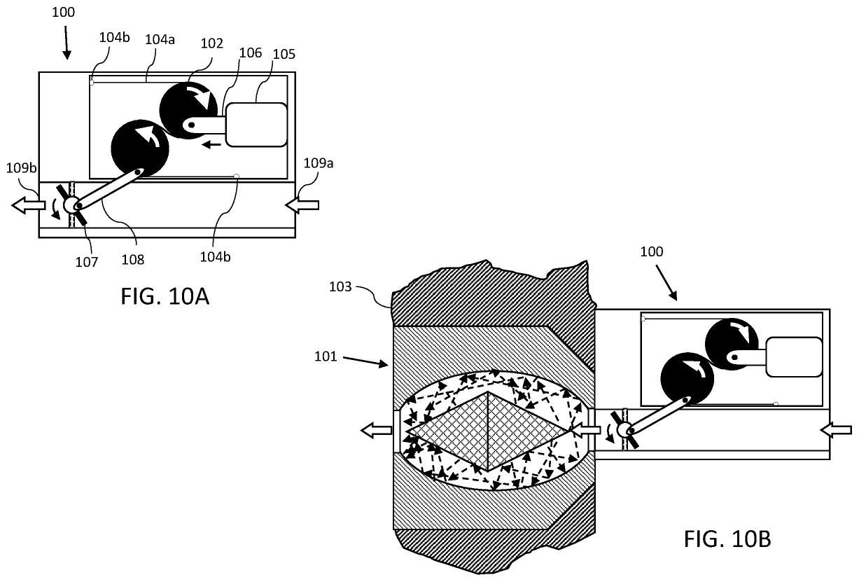

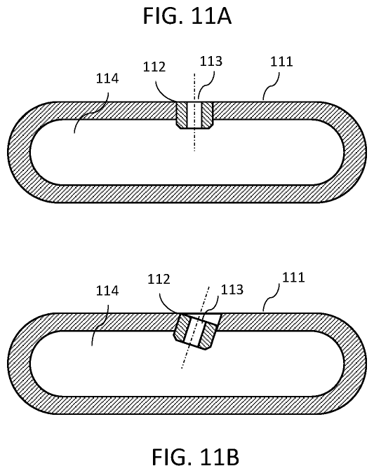

Referring now to FIGS. 10A and 10B, rolamite valve body 100, with rollers 102 (held by tension band and anchors 104a-b) may be coupled to actuator 105 via actuator arm 106. A valve, for example, a butterfly valve 107 may couple to rollers 102 through valve arm 108. Fluid may then pass through inlet 109a and out through outlet 109b. Such a butterfly flow control valve with a rolamite mechanism may, as shown in FIG. 10B, connect to an insert body 101. Insert bodies may be incorporated into manifolds or other fluid passage structures. The insert body may include fluid exit orifice(s), chaotic cavities, valves, metamaterials, etc., and may be threaded, for example, for interchangeability. Alternatively, the insert body may be brazed, welded, etc., for permanent installation. Insert body 101 includes an integrated chaotic cavity, disposed on or in manifold wall 103. The fluid may then pass through the valve inlet, through the butterfly valve, through the valve outlet, and then through the chaotic cavity. The insert body 101 may angle the exit orifice in the manifold. Referring now to FIGS. 11A and 11B, insert body 112 within manifold 111 allows fluid from the fluid passage 114 to pass through the manifold 112. The insert body 112 may be angled (FIG. 11B) or not angled (FIG. 11B) with respect to the manifold 111.

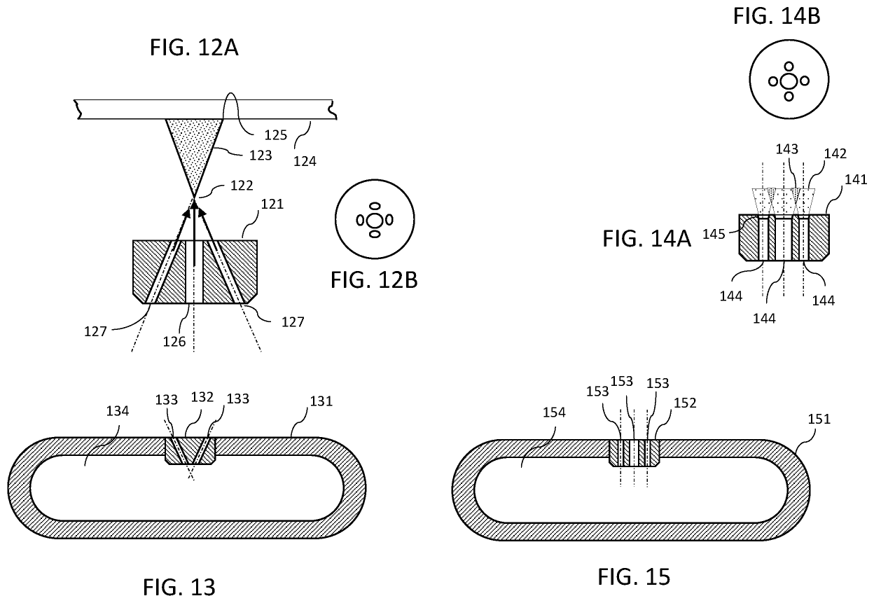

In some implementations, the fluid emitter may emit fluid from more than one orifice simultaneously. The orifices may emit the same fluid, or mix more than one type of fluid. For example, as shown in FIG. 12A, an insert body 121 with an orifice 126 and angled orifices 127 may emit fluid such that the emitted fluids converge at collision or shattering intersection point 122. Emissions from the orifices 126 may intersect or overlap at any distance from the tool for complex mixing behavior. The shattered fluid 123 then impacts the tubular or structure 124 at the engagement point 125. FIG. 13B illustrates a frontal view of insert body 121, orifices 126, and angled orifices 127. As shown in FIG. 13, the fluids may instead diverge instead of converge, as manifold 131 with insert body 132 includes diverging orifices 133 that divert the fluid from the fluid passage 134. In another aspect, the emitted fluid may mix after the parallel orifices 144 emit the fluid. As shown in FIG. 14A, an insert body 141 with parallel orifices 144 may emit fluid with exit patterns 142 and overlap mixing area 143. The orifices 144 may include a countersink 145 for configuring discharge angle. FIG. 15 illustrates parallel orifices 153 with manifold 151 and insert body 152 controlling fluid passage 154.

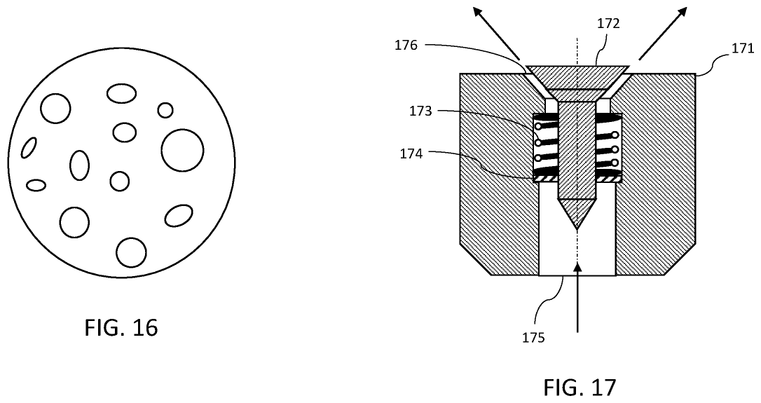

In some examples, random orifice locations that emit fluid at various angles are used to generate additional chaotic fluid discharge behavior (FIG. 16). As illustrated in FIG. 17, an insert body 171 may include a pintle 172 with biasing element (e.g., spring) 173 with retainer or guide clip 174. Fluid enters at inlet 175 and exits at annular outlet 176. The position of the pintle 172 set by biasing element 173 provides a variable area fluid emission orifice.

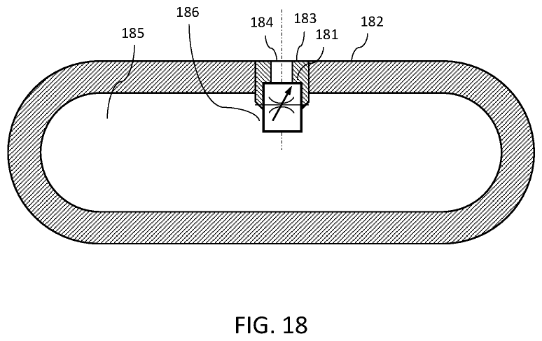

Referring now to FIG. 18, a manifold 182 containing fluid passage 185 may include valve 181. The valve 181 be disposed on or partially or completely within an insert body 183 with orifice 184. A flow control valve 186 controls the flow of the fluid through the orifice. Optionally, a controller operates the valve.

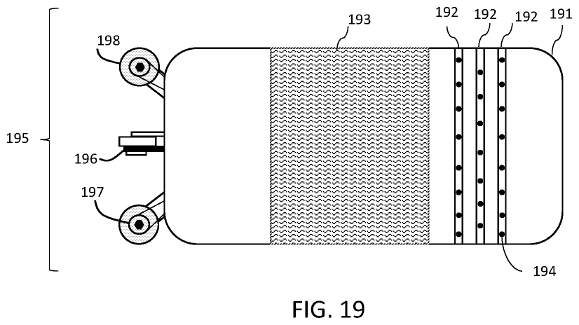

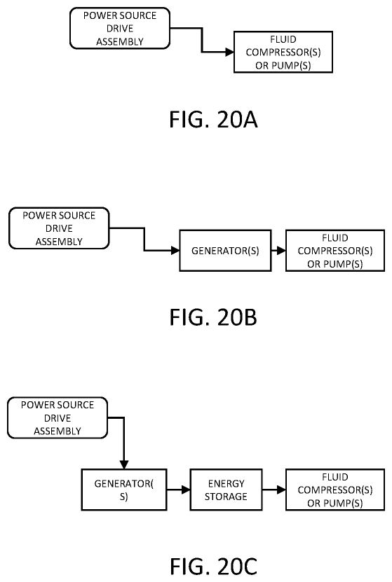

In accordance with an aspect of the present invention, a relative motion power source for the fluid emitter system, as shown in FIG. 19, includes a tool body 191 with manifolds 192 and sensing region 193. The manifolds includes orifices or insert bodies 194. The tool 191 may be powered by power source drive assembly 195 that includes drive belt or chain 196, drive hub or gear 197, and wheel 8. As the tool is propelled along or through the conduit or structure, the wheel(s) 198, in contact with the surface of the conduit, revolve. This relative motion between the tool 191 and the conduit can be transformed into power through the revolution of the wheel 198. As the wheel 198 revolves, drive hub or gear 197 turns and drives drive belt or chain 196, which may be coupled to any number of generators or power generation means, including an electric generator, compressor, or pump. Alternatively, power or energy storage could be filled via the power source drive assembly 195, or any combination of storage and generators (FIG. 20A-C). In addition to power generation, the wheels may also serve as odometers or encoders to measure distance travelled or depth. Two or more wheels may act as stabilizers for stabilizing the tool in a desired location (e.g., the center) of the tubular.

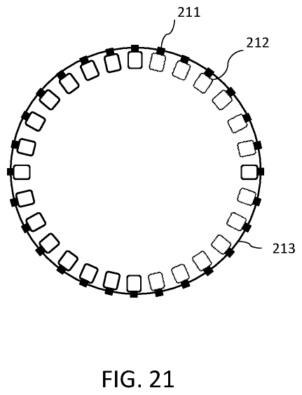

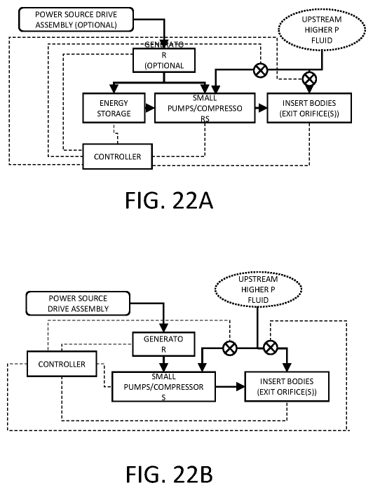

A fluid emitter tool may have a plurality of pumps and compressors located at discrete locations around the tool. As shown in FIG. 21, a tool 213 has a plurality of pumps or compressors 212, each including an insert body or fluid exit point 211. The previously discussed generators, energy storage, or pressure differentials may power the pumps or compressors 212, as shown in FIGS. 22A and 22B. Valves (optionally operated by a controller) may regulate the flow of fluids between the pumps and orifices.

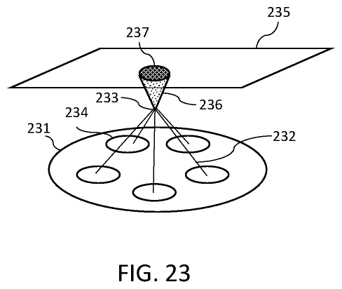

Referring now to FIG. 23, an insert body 231 includes orifices 234, which may be similar to those previously discussed above with respect to FIGS. 12 and 13. Orifices 234 may be angled to create fluid discharge path 232, which causes the emitted fluid to converge at shattering intersection point 233. The shattered fluid 236 impinges the conduit or structure 235 at the shattered fluid engagement point 237.

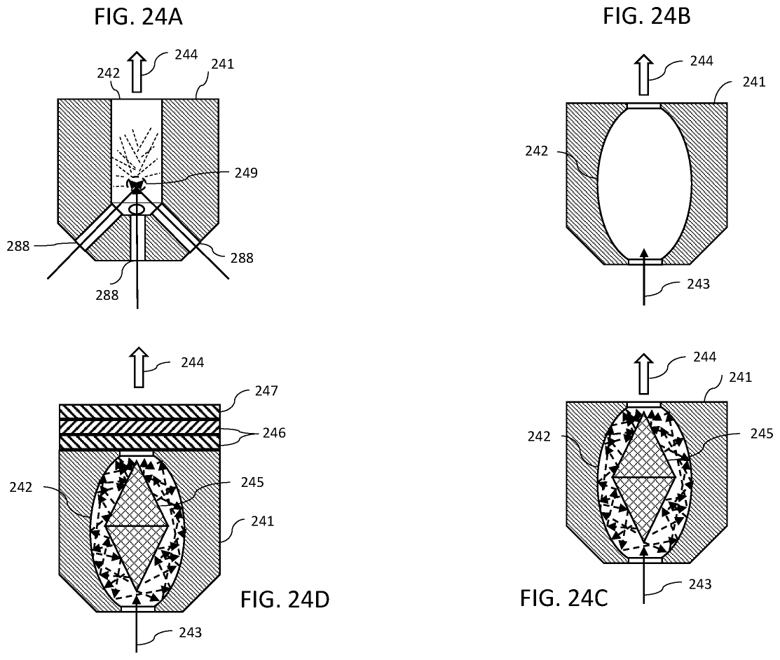

FIGS. 24A-D depict exemplary insert bodies with integrated chaotic cavities. Insert body 241 includes chaotic cavity 242. The chaotic cavity 242 may include multi-surfaces or other anomalies. For example, FIGS. 24C-D include reflectors 245. Fluid may enter the insert body 241 at fluid entrance 243 and exit at outlet 244. The insert body 241 may also include metamaterial filters 246 or metamaterial focusing 247 (see FIG. 24D). The insert body 241, in some examples, draws fluid in through orifices 248, where the fluid intersects at shattering intersection point 249 before exiting through outlet 244 (see FIG. 24A).

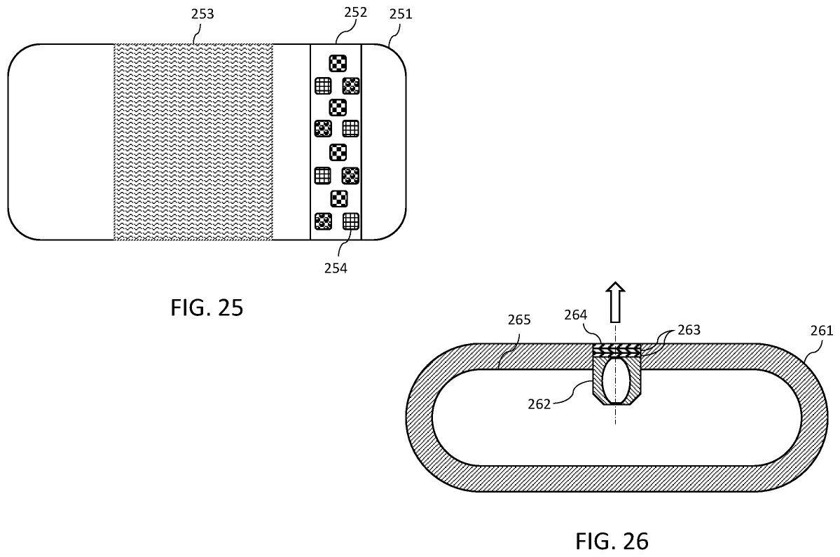

Referring now to FIG. 25, a tool body 251 with manifold 252 and sensing region 253 includes emission metamaterials 254 (such as by utilizing aspects of the systems described in U.S. patent application Ser. No. 15/897,666, filed Feb. 15, 2018, which is hereby incorporated herein by reference in its entirety). As shown, the manifold 252 may be integrated with metamaterials at fluid exits. Exemplary benefits of such use of metamaterials include emission intensification, impedance matching, steering, cloaking, attenuation, computing functions (e.g., such as real-time FFTs) etc., as passive or active devices (with control of parameters dynamically). In another view, FIG. 26 depicts manifold 261 including fluid passage 265 and an insert body with integrated chaotic cavity 262 that includes metamaterial filters/focusers 263 and metamaterial impedance matching 264. Chaotic cavities and metamaterials may also be incorporated within a tool body without a manifold, instead receiving fluid from conduits or channels.

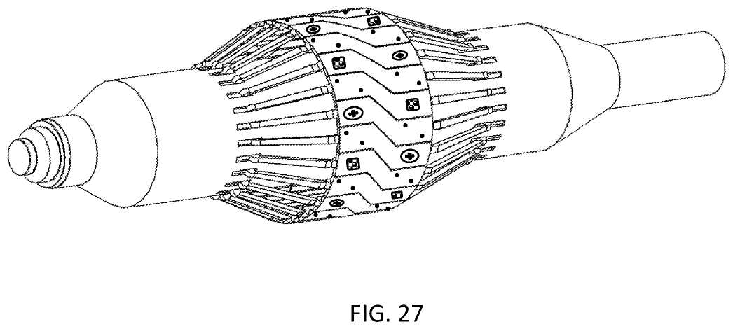

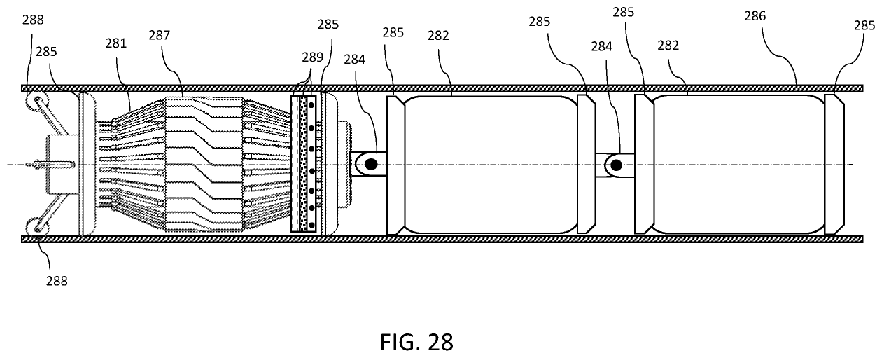

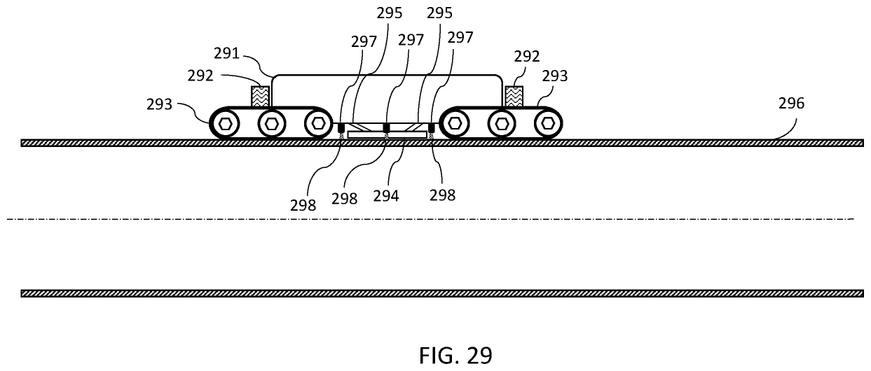

In accordance with the present invention, a tool, such as the tool illustrated in FIG. 27, includes exit orifices, insert bodies, and metamaterials integrated into the sensor shows for downhole applications. As shown in FIG. 28, tool module 281 may include a number of other modules 282 for some combination of fluid and energy storage. As a module is depleted (e.g., of energy or fluid), the tool may seamlessly switch to another module to maintain continuous or on-demand system operation. The modules may be coupled via universal joint 284 and each module may be preceded or followed by a drive cup, centralizer, and cleaning ring 285 as the tool 281 is propelled through tubular 286. The tool may include sensor shoes 287 and power source drive wheel assembly 288. Manifolds 289 may be included in a variety of sizes and shapes to emit fluid for detecting flaws in the tubular 286. Alternatively, as shown in FIG. 29, the tool 291 may move along the outer surface of a tubular or structure 296. A transverse drive 292 and axial drive 293 propel the tool 291 in all directions. Sensing device 294, optionally with integrated fluid emission exits, may be coupled to sensing device arms 295. Insert body with orifices 297 emits fluid, and the fluid impinges the tubular at 298.

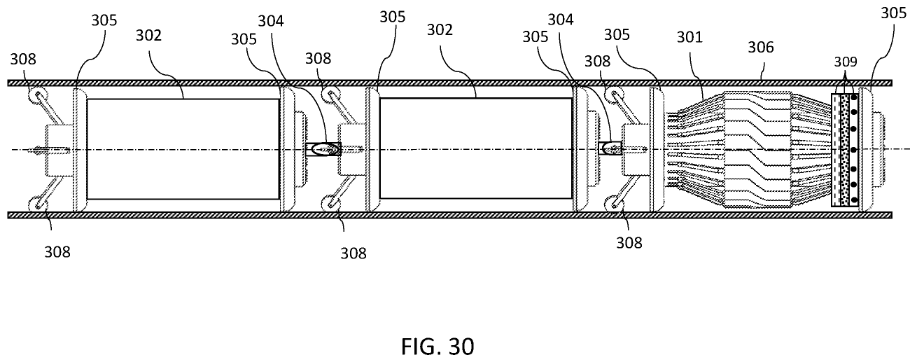

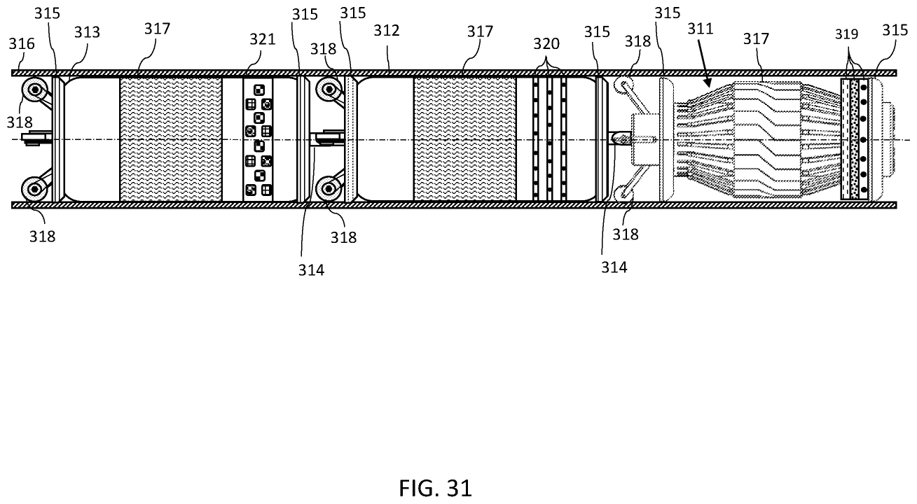

FIG. 30 illustrates another implementation, with tool 301 a plurality of modules 302 coupled via universal joints 304. The plurality of modules 302 may include a plurality of fluid emitters, fluid storage, fluid source, energy storage, or some combination thereof. Each module may include drive cup, centralizer, and/or cleaning ring 305 in contact with tubular 306. Sensor shoes 307 may be disposed on and around the tool 301 and power source drive wheel assembly 308 may provide power to the tool 301 while also serving as an odometer or encoder. Manifolds 309 include orifices to emit fluid to impinge the tubular 306. In another implementation, FIG. 31 depicts tool 311 with modules 312 and 312 coupled via universal joint 314. Each module may include drive cup, centralizer, and/or cleaning ring 315 in contact with tubular 316. Sensor shoes or region 317 may be disposed on and around the tool 311 and power source drive wheel assembly 318 may provide power to the tool 311 while also serving as an odometer or encoder. Manifolds 319 include orifices to emit fluid to impinge the tubular 316. Manifolds 320 may also include integrated small insert bodies while manifolds 321 may include various emission metamaterials.

The present invention may collect and process data via a data processor, which may be part of the tool or may be remote from the tool (and may process data transmitted from the tool or collected by the tool and processed after the tool has completed its data collection).

Therefore, the present invention provides a tool that can be operated in pipelines (e.g., inline inspection), downhole applications, other tubulars and structures of various geometry, for the purpose of, for example, crack and flaw detection. The tool may utilize means for positional and/or spatial relationship via items such as a caliper, encoder, gyroscopic devices, inertial measurement unit (IMU), and/or the like. The tool may also utilize a caliper module for determination of geometry flaws, dents, etc.

Optionally, the tool of the present invention may utilize individual sensor(s) or array(s) unlimitedly disposed in uniform or non-uniform arrangements/patterns for the sensing technologies and/or methods. The tool may utilize an electro-magnetic acoustic transducer and/or an ultrasonic transducer, etc., to impart acoustic energy into the material under test in conjunction with fluids.

The tool may store data on-board, or may transmit it to a remote location for storage (and/or processing), or a combination of both. The tool may employ advanced data processing techniques to isolate and extract useful data as required. The tool may employ advanced data processing techniques that use a single sensing technology and/or method, or any combination of sensing technologies (together or individually) and/or methods. Data processing may be conducted in real-time during tool operation, off-loaded externally to be conducted after completion of a tool operation, or a combination of both.

As previously discussed, the tool may be powered on-board (via the power source drive wheel assembly or other power sources), remotely, or a combination of both. The tool may have a system and method to clean surfaces for better sensing abilities, and that system may be incorporated with at least one module if utilized in the tool.

The tool may be operated in tubulars with a wide variety of diameters or cross-sectional areas. Optionally, the tool may be attached to other tools (such as, for example, material identification, magnetic flux leakage, calipers, etc.). The tool may simultaneously use the aforementioned sensing technologies and/or enhancements with existing tools' sensing capabilities and/or system(s)—(such as, for example, crack detection system(s) utilize other tool capabilities simultaneously through shared componentry, magnetic fields, perturbation energy, waves, etc.).

The tool may include the means to determine position/location/distance such as, but not limited to, global positioning system(s), gyroscopic systems, encoders or odometers, etc. The tool may include the means to determine position, location or distance that stores this data on-board or transmits it to a remote location, or a combination of both. The tool may combine the position, location or distance data simultaneously with sensing data collection at any discrete location within the tubular, or on a structure's surface.

An additional version of a tool may be configured to be mounted externally to a tubular via fixture, frame, cabling, etc. to detect cracks on the exterior surface(s) (see FIG. 29). This version of the tool may have a sensing “suite” that is moved manually, is powered, or is pre-programmed to operate in a pattern.

The tool may utilize a transduction method such as time reversal techniques (via processing code) applied to one or more impedance methods included herein as an enhancement. The tool may utilize virtual phased arrays in the form of one or more virtual emitters and one or more virtual receivers.

The tool may be configured to be conveyed within a borehole to evaluate a tubular within the borehole. The tool may further include a conveyance device configured to convey the tool into the borehole. The tool may be configured to be conveyed into and within the borehole via wireline, tubing (tubing conveyed), crawlers, robotic apparatuses, and/or other means.

Therefore, the present invention provides a tool or device that utilizes a sensing system or device or means to sense and collect data pertaining to cracks or flaws in the pipe or conduit or other structures in or on which the tool is disposed. The tool utilizes a fluid emitter to impinge the conduit or structure with fluid. The impingement creates a response in the structure that may be sensed. The sensed data is processed and analyzed to determine the cracks or flaws in the pipe or structure at various locations along the conduit or pipeline or structure.

Optionally, aspects of the tool and system of the present invention may be utilized for freepoint sensing purposes, positive material identification (PMI) sensing purposes and stress mapping purposes, while remaining within the spirit and scope of the present invention.

Changes and modifications to the specifically described embodiments may be carried out without departing from the principles of the present invention, which is intended to be limited only by the scope of the appended claims as interpreted according to the principles of patent law including the doctrine of equivalents.

1. A flaw detecting system operable to detect flaws along a conduit or structure, the flaw detecting system comprising:
a tool movable along a conduit or structure and having at least one sensing device for sensing flaws in a wall of the conduit or structure;
wherein the sensing device comprises a fluid emitter;
wherein the fluid emitter comprises at least one orifice configured to emit fluid;
wherein, responsive to the orifice emitting fluid, the emitted fluid excites the conduit or structure;
wherein the sensing device senses a response from the excitation of the conduit or structure;
a processor operable to process the response sensed by the sensing device; and
wherein, responsive to processing of the response by the processor, the processor determines flaws present at the wall of the conduit or structure.

2. The flaw detecting system of claim 1, wherein the emitted fluid excites the conduit or structure at least one of periodically, chaotically, hyperchaotically, randomly, and via noise.

3. The flaw detecting system of claim 1, wherein the tool comprises a plurality of modules.

4. The flaw detecting system of claim 3, wherein the plurality of modules comprises a plurality of fluid emitters.

5. The flaw detecting system of claim 3, wherein at least one of the plurality of modules comprises a fluid storage module.

6. The flaw detecting system of claim 3, wherein at least one of the plurality of modules comprises a power source module.

7. The flaw detecting system of claim 1, wherein the fluid emitter comprises at least one manifold.

8. The flaw detecting system of claim 7, wherein the at least one orifice comprises a plurality of orifices disposed on the at least one manifold.

9. The flaw detecting system of claim 7, wherein the at least one manifold includes at least one insert body.

10. The flaw detecting system of claim 9, wherein the at least one insert body includes at least one chaotic cavity.

11. The flaw detecting system of claim 10, wherein the at least one chaotic cavity comprises a metamaterial structure.

12. The flaw detecting system of claim 9, wherein the at least one insert body comprises a valve, wherein the valve regulates the fluid emitted from the orifice.

13. The flaw detecting system of claim 7, wherein the at least one manifold comprises a pump.

14. The flaw detecting system of claim 1, wherein the tool comprises at least one sensing shoe, the at least one sensing shoe comprising a manifold, the manifold comprising a fluid inlet and a fluid outlet.

15. The flaw detecting system of claim 14, wherein the sensing shoe comprises at least one insert body.

16. The flaw detecting system of claim 15, wherein the at least one insert body comprises at least one chaotic cavity.

17. The flaw detecting system of claim 16, wherein the at least one chaotic cavity comprises a metamaterial.

18. The flaw detecting system of claim 15, wherein the at least one insert body comprises a valve, and wherein the valve regulates the fluid emitted from the orifice.

19. The flaw detecting system of claim 1, wherein the tool comprises at least one valve, and wherein the valve regulates the fluid emitted from the orifice.

20. The flaw detecting system of claim 19, wherein the at least one valve comprises at least one high-speed valve configured to pulse the regulated fluid emitted from the orifice.

21. The flaw detecting system of claim 20, wherein the at least one high-speed valve comprises a rolamite mechanism.

22. The flaw detecting system of claim 1, wherein the tool comprises at least one fluid compressor, and wherein the fluid compressor compresses the fluid emitted from the orifice.

23. The flaw detecting system of claim 1, wherein the tool comprises a pump, the pump configured to pump fluid to the fluid emitter.

24. The flaw detecting system of claim 1, wherein the tool comprises a power source, the power source configured to power the tool.

25. A method for detecting flaws along a conduit or structure, the method comprising:
providing a tool comprising at least one sensing device for sensing flaws in a wall of the conduit or structure, wherein the at least one sensing device comprises a fluid emitter, and wherein the fluid emitter comprises at least one orifice configured to emit fluid;
moving the tool along the conduit or structure;
exciting the conduit or structure with fluid emitted from the at least one orifice;
with the conduit or structure excited by the emitted fluid, collecting a response from the conduit or structure with the at least one sensor;
processing the response from the conduit or structure; and
determining, based at least in part on the processing of the response, flaws at the wall of the conduit or structure.

26. The method of claim 25, wherein exciting the conduit or structure comprises exciting the conduit or structure at least one of periodically, chaotically, hyperchaotically, randomly, and via noise.

27. The method of claim 25, wherein exciting the conduit or structure comprises dynamically controlling the orientation of the emitted fluid.

28. The method of claim 25, wherein the at least one orifice comprises at least two orifices, and wherein exciting the conduit or structure comprises intersecting fluid emitted from at least two orifices, and wherein the emitted fluid from the at least two orifices mixes prior to exciting the conduit or structure.

29. The method of claim 25, wherein the fluid emitter emits fluid collected from an environment surrounding the tool.

30. The method of claim 25, wherein the tool comprises a fluid storage module, and wherein the fluid emitter emits fluids stored in the fluid storage module.

31. The method of claim 25, wherein fluid emitted from the at least one orifice comprises a plurality of fluids, and wherein the plurality of fluids includes at least a first fluid and a second fluid, the second fluid different from the first fluid.

32. The method of claim 25, wherein exciting the conduit or structure comprises controlling at least one valve to regulate the emitted fluid.

33. The method of claim 32, wherein controlling the at least one valve comprises controlling at least one high-speed valve.

34. The method of claim 33, wherein the at least one high-speed valve comprises a rolamite mechanism.

35. A power source drive assembly for a flaw detecting system operable to detect flaws along a conduit or structure, the power source drive assembly comprising:
at least one wheel coupled to a tool movable along the conduit or structure, the at least one wheel in contact with the conduit or structure and configured to revolve when the tool moves along the conduit or structure; and
a generator coupled to the at least one wheel and configured to generate power in response to the at least one wheel revolving wherein the generated power at least in part powers the tool, wherein the generator comprises one of an electric generator, a compressor, or a pump.

36. The power source drive assembly of claim 35, wherein the tool comprises at least one sensing device for sensing flaws in the wall of the conduit or structure, and wherein the at least one sensing device comprises a fluid emitter, and wherein the generated power at least in part powers the fluid emitter.

37. The power source drive assembly of claim 36, wherein the at least one wheel comprises at least three wheels, and wherein the at least two wheels are configured to stabilize the tool in a center of the conduit or structure.

38. The power source drive assembly of claim 36, wherein the at least one wheel comprises an odometer configured to measure a distance the tool travels in the conduit or structure.

39. The power source drive assembly of claim 35, wherein at least one wheel coupled to the tool is coupled to a pump or compressor such that rotation of the at least one wheel drives the pump or compressor.
